(19) United States
(12) Patent Application Publication
(10) Pub. No.: US 2026/0093163 A1
(43) Pub. Date: Apr. 2, 2026

(54) UNDERCARRIAGE PHOTOGRAPHY APPARATUS

(71) Applicant: Carvana IPHC, LLC, Tempe, AZ (US)

(72) Inventors: Charles Veneklase, Tempe, AZ (US); Brian Srock, Tempe, AZ (US); Daniel Stelly, Tempe, AZ (US); Bruce Moehl, Tempe, AZ (US)

(73) Assignee: Carvana IPHC, LLC, Tempe, AZ (US)

(21) Appl. No.: 18/905,072

(22) Filed: Oct. 2, 2024

(51) Int. Cl. G03B 17/56; F16M 11/04

(52) U.S. Cl. CPC G03B 17/561; F16M 11/048; F16M 2200/04

(57) ABSTRACT

An apparatus for photographing an undercarriage of a vehicle may have a telescoping central support, a camera, and a leveling weight. The apparatus may aid in consistent photography of the undercarriage of the vehicle by providing a consistent set up for an undercarriage photography shot.

### TECHNICAL FIELD

This disclosure generally relates to systems and methods for photography, and more specifically, to an apparatus and methods for facilitating the photography of vehicles.

### BACKGROUND

The online advertisement and sale of vehicles is a major industry, allowing buyers to see a wide variety and selection of vehicles for sale. Vehicles may be posted on various websites and platforms by an individual vehicle owner or may be posted by a company that buys and sells vehicles. Such a business may have a large volume of vehicles that are typically listed for sale. A major component of these vehicle listings are the photographs included with the listings. To best attract buyers, the photos should be high quality and high in quantity. Many angles and aspects of each vehicle should often be captured to allow potential buyers to gain an understanding of each vehicle's condition and appearance. Consistency between photographs is also important to allow potential customers to compare vehicles. However, for a business with a large volume of vehicles that are being listed, detailed and consistent photography may be difficult, time-consuming, and expensive. Certain angles and aspects of the vehicles may involve special skills, burdensome maneuvers by employees, or expensive lifting apparatuses to appropriately capture.

Therefore, in view of the above, a need exists for a system and method to streamline and ease the photographing of hard-to-reach vehicle aspects and angles.

### SUMMARY

Many embodiments can comprise an apparatus for photographing an undercarriage of a vehicle. The apparatus can comprise a telescoping support comprising a first end and a second end; a weight coupled to the first end of the telescoping support; a camera coupled to the second end of the telescoping support; and a housing slidably coupled to the telescoping support.

Some embodiments can comprise a method of creating an apparatus for photographing an undercarriage of a vehicle. The method can comprise coupling a weight to a first end of a telescoping support; coupling a camera to a second end of the telescoping support; and slidably coupling a housing to the telescoping support.

Various embodiments can comprise a method for using an apparatus for photographing an undercarriage of a vehicle. The method can comprise sliding the apparatus for photographing the undercarriage of the vehicle underneath the vehicle, wherein the apparatus for photographing the undercarriage of the vehicle can comprise: a telescoping support comprising a first end and a second end; a weight coupled to the first end of the telescoping support; a camera coupled to the second end of the telescoping support; and a housing slidably coupled to the telescoping support; actuating the camera; and removing the apparatus for photographing the undercarriage of the vehicle from underneath the vehicle.

### BRIEF DESCRIPTION OF THE DRAWINGS

To facilitate further description of the embodiments, the following drawings are provided in which:

FIG. 1 illustrates an opaque view of an exemplary apparatus for undercarriage photography, in accordance with various embodiments;

FIG. 2 illustrates an exemplary transparent, exploded view of a housing assembly, in accordance with various embodiments;

FIG. 3 illustrates an exemplary transparent, exploded view of a camera assembly, in accordance with various embodiments;

FIG. 4 illustrates an exemplary transparent exploded view of a weight assembly, in accordance with various embodiments;

FIG. 5A illustrates opaque view of an exemplary apparatus for undercarriage photography, in accordance with various embodiments;

FIG. 5B illustrates an exploded view of the exemplary apparatus for undercarriage photography shown in FIG. 5A, in accordance with various embodiments; and

FIG. 6 illustrates an exemplary transparent view of a housing, in accordance with various embodiments.

### DETAILED DESCRIPTION

In many embodiments, the techniques described herein may provide a practical application and several technological improvements. In many embodiments, the techniques described herein may provide for increased efficiency and increased quality in photography. These techniques described herein may provide a significant improvement over conventional approaches of vehicle photography, such as manual photography, wherein a person may have to be physically positioned under a vehicle. In many embodiments, the techniques described herein may beneficially allow taking of photos of the underside of a vehicle, for use especially when selling a vehicle to provide a complete visual description of the vehicle to potential customers. In this way, the techniques described herein may avoid problems with low quality photography that may impede the sale of cars through online listings.

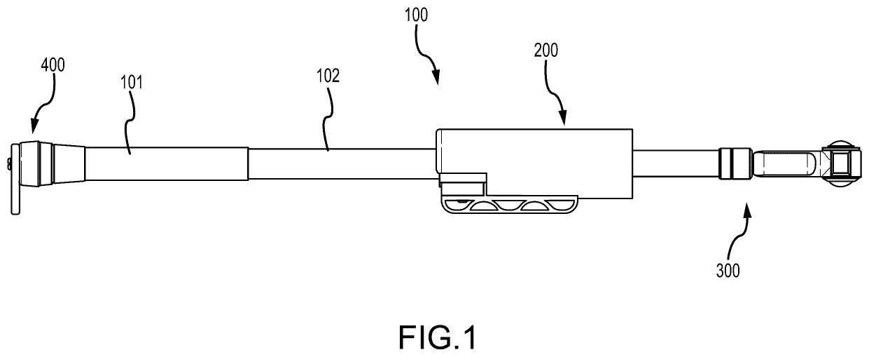

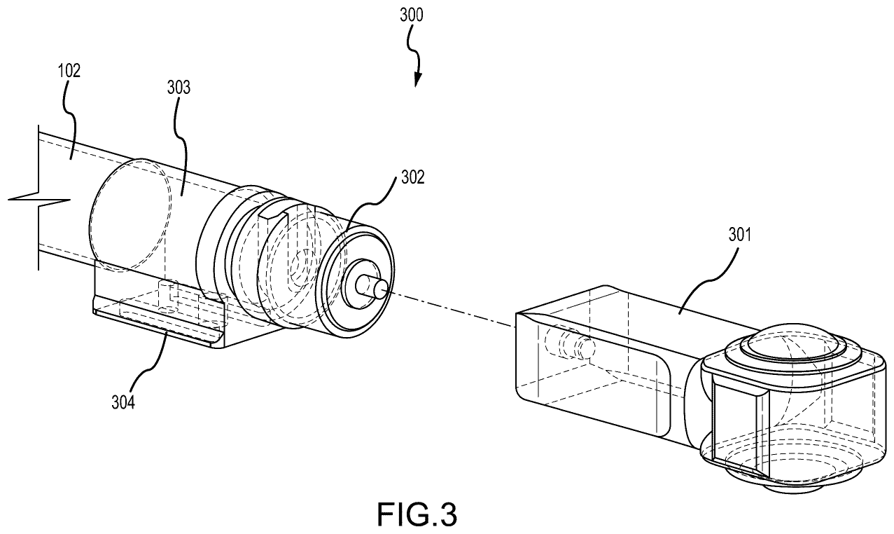

Turning to the drawings, FIG. 1 illustrates an opaque view of an apparatus for undercarriage photography 100. Apparatus 100 may comprise a first central support 101, a second central support 102, a housing assembly 200, a camera assembly 300, and an end assembly 400. While first central support 101 and second central support 102 are shown as cylinders, a person having ordinary skill in the art will understand that other cross sectional shapes may be used (e.g., square, triangle, hexagon, etc.). The second central support 102 may fit inside the first central support 101, allowing extension and contraction of apparatus 100. To shorten the length of apparatus 100, the second central support 102 may fit partially or entirely within the first central support 101. In many embodiments, a telescoping motion of apparatus 100 may be adjusted by manually pulling or pushing on the first central support 101 or the second central support 102. In many embodiments, apparatus 100 may comprise a motor to mechanically extend or contract first central support 101 or second central support 102. The motor can be actuated via one or triggering mechanisms or controllers, thereby causing apparatus 100 to extend and/or contract (depending on the signal received). In many embodiments, extension and/or contraction of apparatus 100 can be controlled by one or more computer systems. The computer system can be programmed with a total extension length, and then extend/contract to either a pre-programmed or customized percentage of that length when requested by a user. The computer system can also be programmed with one or more operational routines for apparatus 100. For example, the computer can be programmed to, upon the actuation of a triggering mechanism, cause apparatus 100 to extend, cause a camera (e.g., camera 301 (FIG. 3)) to capture photographs, and then cause apparatus 100 to contract.

In many embodiments, apparatus 100 can comprise more than two central supports, thereby allowing for additional telescoping motion. In many embodiments, there may be a stopping or locking device to hold the first central support 101 in place, thereby allowing the telescoping cylindrical arm to maintain a given length while photography is in progress. For example, a stopping device may comprise a rubber ring placed inside the first central support 101 that applies tension on the second central support 102. As another example, a stopping or locking device may comprise one or more spring-loaded pins coupled to the second central support 102 that may fit into one or more holes in the first central support 101. In this embodiment, apparatus 100 may be unlocked by releasing or depressing the spring-loaded pins. In many embodiments, the first central support 101 and second central support 102 may be threaded to allow the second central support 102 to screw into the first central support 101.

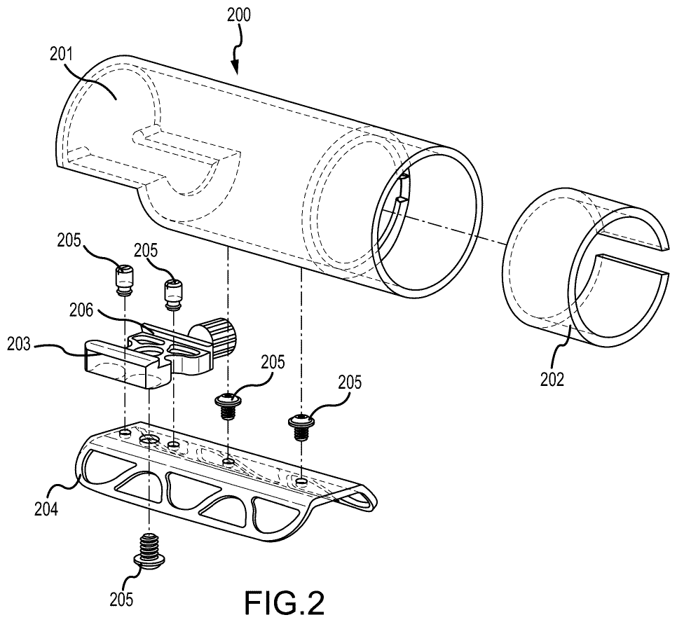

Turning now to FIG. 2, a transparent, exploded view of housing assembly 200 is shown. Housing assembly 200 may be shaped to accommodate a slidable coupling to one or more of first central support 101 (FIG. 1) or second central support 102. Housing assembly 200 may comprise a cavity large enough to house and/or provide protection to camera assembly 300 (FIG. 1). Housing assembly 200 may comprise housing 201, liner 202, mount 203, and sled 204. Housing 201 may be constructed of a material having the strength and durability to resist various forces or conditions. For example, housing 201 may be made of metal alloys, plastics, or woven fiber composites (e.g., carbon fiber). Housing 201 may have a number of cutouts or recesses to assist in coupling additional elements of housing assembly 200 or receiving additional elements of apparatus 100 (FIG. 1). For example, liner 202 and/or mount 203 may be coupled to housing 201 in their own respective cutout or recess. As another example, a cutout on housing 201 may be used as a guide to aid in sliding housing assembly over camera assembly 300 (FIG. 1). As a third example, housing 201 can comprise an opening that allows access to an interior of housing 201, thereby allowing maintenance, repair, or charging of components stored within housing 201. Liner 202 may be constructed of a soft and/or cushiony material capable of lowering forces exerted on camera assembly 300 (FIG. 1) and/or protecting elements of camera assembly 300 (FIG. 1) from damage to due to dust, dirt, grime, or other deleterious elements. For example, liner 202 may have a felt or microfiber exterior. As another example, liner 202 may be cushioned or padded to absorb jostles and bumps during transport, storage, or usage of apparatus 100 (FIG. 1). In many embodiments, liner 202 may be removably coupled to housing 201 (e.g., via hook and loop fasteners), thereby allowing it to be cleaned or replaced.

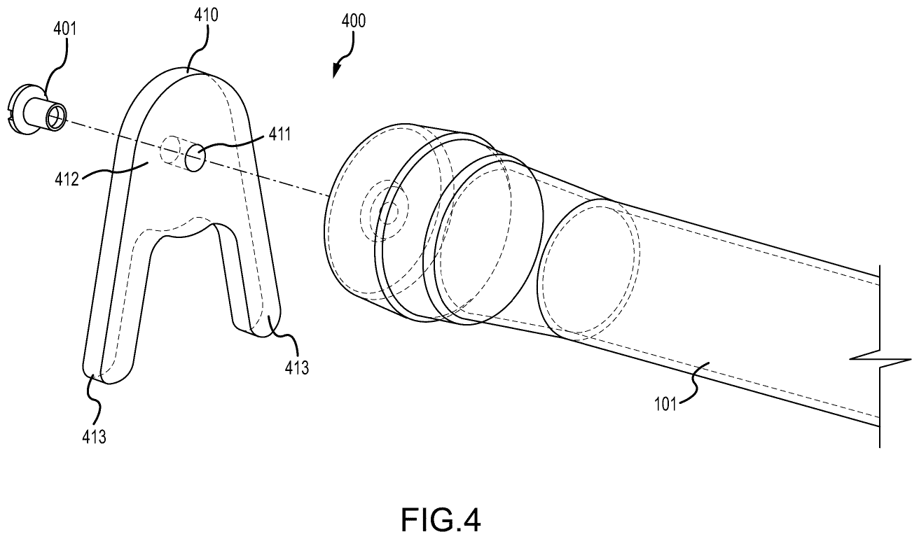

Mount 203 may be used to couple sled 204 to housing 201. In many embodiments, mount 203 may be a quick release mount that allows sled 204 to be coupled and uncoupled with ease. Mount 203 may further comprise a level indicator (e.g., a level vial) capable of informing an operator when camera assembly 300 (FIG. 1) has a level shot of an undercarriage. In many embodiments, mount 203 may have one or more cutouts or recesses to assist in receiving elements of housing 201. For example, mount 203 may comprise one or more grooves 206 for receiving corresponding protrusions or rails on housing 201. As another example, housing 201 can comprise a female portion of an Arca-Swiss mount and mount 203 can comprise a male portion of an Arca-Swiss mount. Sled 204 may rest on a floor when apparatus 100 (FIG. 1) is in use. Sled 204 may allow an operator of apparatus 100 (FIG. 1) to easily slide apparatus 100 (FIG. 1) underneath a vehicle so that the vehicle undercarriage may be photographed. A size, shape, or assembly of sled 204 can allow apparatus 100 (FIG. 1) to be level when in use. For example, sled 204 can raise housing assembly 200 to a position where housing assembly 200 is at an equal height with end assembly 400 (FIG. 4). As another example, mount 203 can be used as a spacer that places housing assembly 200 at an equal height with end assembly 400 (FIG. 4). In many embodiments, a portion of sled 204 in contact with the ground (or the ground itself) may be coated in a low friction substance (e.g., wax, nylon) to allow for easier sliding into or out of an undercarriage view of a vehicle. Various fasteners 205 may be used to couple one or more elements of housing assembly 200 together. Sled 204 may have a number of cutouts or recesses to assist in coupling or receiving additional elements of apparatus 100 (FIG. 1). For example, sled 204 can comprise an opening that allows access to an underside of housing 201. In these embodiments, the opening can be aligned with an opening in the underside of housing, thereby allowing maintenance, repair, or charging of components stored within housing 201. One more ore wheels can be coupled to sled 204. Wheels coupled to sled 204 can be coupled at a variety of points on sled 204. For example, wheels can be mounted at a front, middle, or back of sled 204. Further, wheels can me mounted proximate to a top or bottom of sled 204 to vary a height of the wheels while still maintaining a level photographic apparatus (e.g., in conjunction with leveler 410 (FIG. 4)).

Turning now to FIG. 3, a transparent, exploded view of camera assembly 300 is shown. Camera assembly 300 may comprise camera 301, camera mount 302, and housing mount 303. Camera 301 may comprise a device capable of capturing one or more images and/or videos. A number of types of cameras may be used as camera 301. For example, a 360 degree camera, a fisheye camera, or some other type of wide angle camera may be used to photograph an undercarriage of a vehicle. Camera 301 may be actuated remotely and/or locally by one or more controllers (e.g., one or more computer systems). In many embodiments, camera 301 may connect to one or more controllers in a wired or wireless fashion. In many embodiments, actuation of camera 301 may be achieved by one or more timers. Images captured by camera 301 can be uploaded to one or more computer systems via one or more networks (e.g., the Internet) for storage, processing, and retrieval. For example, images captured by camera 301 can be uploaded to a web server for display on a website.

Camera 301 can be electrically coupled to one or more batteries. The one or more batteries can be internal and/or external to camera 301. In embodiments where an external battery is used, the battery can be located in a number of different locations. For example, a battery can be located on housing assembly 200. In these embodiments, a battery can be coupled to an underside of sled 204 (FIG. 2), between housing 201 (FIG. 2) and sled 204 (FIG. 2), and/or inside of housing 201. In many embodiments, a battery can replace or be a part of camera mount 302. In some embodiments, a battery can be located in between camera mount 302 and camera 301 or between camera mount 302 and housing mount 303. Camera 301 can be in data communication with one or more remote computer systems (e.g., a computer system embedded in a photographic apparatus or accessible via one or more wireless and/or wired networks).

Camera mount 302 may function to couple camera 301 to first central support 101 (FIG. 1), second central support 102, or housing mount 303. In many embodiments, camera mount 302 may be integral with one or more of first central support 101 (FIG. 1), second central support 102 (FIG. 1), or housing mount 303. In many embodiments, camera mount 302 may be removable coupled to one or more of first central support 101 (FIG. 1), second central support 102 (FIG. 1), or housing mount 303. For example, a protrusion on camera mount 302 may be complementary shaped to and slid into a cutout or groove on one or more of first central support 101 (FIG. 1), second central support 102 (FIG. 1), or housing mount 303 to couple them together. As another example, a spring-loaded pin or fastener may be used to couple camera mount 302 to one or more of first central support 101 (FIG. 1), second central support 102 (FIG. 1), or housing mount 303. Housing mount 303 may have one or more protrusions 304 capable of coupling with mount 203 (FIG. 2). For example, protrusion 304 may be slidably coupled to groove 206 (FG. 2), thereby coupling housing assembly 200 (FIG. 2) to housing mount 303. Housing mount 303 may have an interior cavity shaped to accommodate slidable coupling to one or more of first central support 101 (FIG. 1) or second central support 102 (FIG. 1). In this way, housing mount 303 may slide a length of apparatus 100 (FIG. 1) along one or more of first central support 101 (FIG. 1) or second central support 102 (FIG. 1). In embodiments where housing assembly 200 (FIG. 2) is coupled to housing mount 303, this slidability may allow housing assembly 200 (FIG. 2) to cover and uncover camera 301. In many embodiments, housing mount 303 may comprise a male portion of an Arca-Swiss mount.

Turning now to FIG. 4, a transparent, exploded view of end assembly 400 is shown. End assembly 400 may comprise a fastener 401 and a leveler 410. Fastener 401 may couple end assembly 400 to one or more of first central support 101 or second central support 102 (FIG. 1). In many embodiments, fastener 401 may arrest rotation of leveler 410 relative to one or more of first central support 101 or second central support 102 (FIG. 1). In many embodiments, fastener 401 may allow leveler 410 to rotate freely, thereby allowing apparatus 100 (FIG. 1) to be rotated while in use. While fastener 401 is shown in FIG. 4 as a screw, it should be understood that other modes can be used to couple leveler 410 to one or more of first central support 101 or second central support 102 (FIG. 1). For example, mount 203 (FIG. 2) or another mount can be used in place of fastener 401.

While end assembly 400 is shown coupled to an end of first central support 101, it should be understood that weight assembly may be coupled at different points along first central support 101 or second central support 102 (FIG. 1). For example, a cutout 411 may be enlarged such that leveler 410 may slide along one or more of first central support 101 or second central support 102 (FIG. 1). In many embodiments, end assembly can comprise a tripod. The tripod can be coupled to apparatus 100 (FIG. 1) via or in place of fastener 401. When in a collapsed configuration, the tripod can function as a handle that allows a user to grasp and maneuver apparatus 100 (FIG. 1) underneath an automobile. When expanded, the tripod can allow apparatus 100 (FIG. 1) to be stood upright while not in use.

Leveler 410 may comprise cutout 411, body 412, and one or more legs 413. Central cutout may comprise an opening in leveler 410 to allow fastener 401 to be used and/or allow leveler 410 to slide along first central support 101 or second central support 102 (FIG. 1). Body 412 may comprise a majority of a mass of leveler 410. In many embodiments, body 412 may be evenly distributed around cutout 411. Legs 413 may extend out or be coupled to body 412. In many embodiments, legs 413 may be of approximately similar or identical length. In this way, leveler 410 may be used to level apparatus 100 (FIG. 1) when legs 413 are rested on a ground. While two of legs 413 are shown in FIG. 4, it should be understood that one leg or more than two legs may be used to the same or similar effect. A size and/or shape of leveler 410 (or one or more of its elements) can allow apparatus 100 (FIG. 1) to be level when in use. For example, legs 413 can raise end assembly 400 to a position where end assembly 400 is at an equal height with camera assembly 300 (FIG. 3). Leveler 410 can be constructed and/or formed from a dense material (e.g., metal), thereby increasing its mass as compared to other elements of apparatus 100 (FIG. 1). In this way, apparatus 100 (FIG. 1) can have its center of mass and/or balance point moved towards housing assembly 200 (FIG. 2). Increased weight in leveler 410 can also allow leveler 410 to better resist jostles and bumps without moving due to increasing a normal force with a surface.

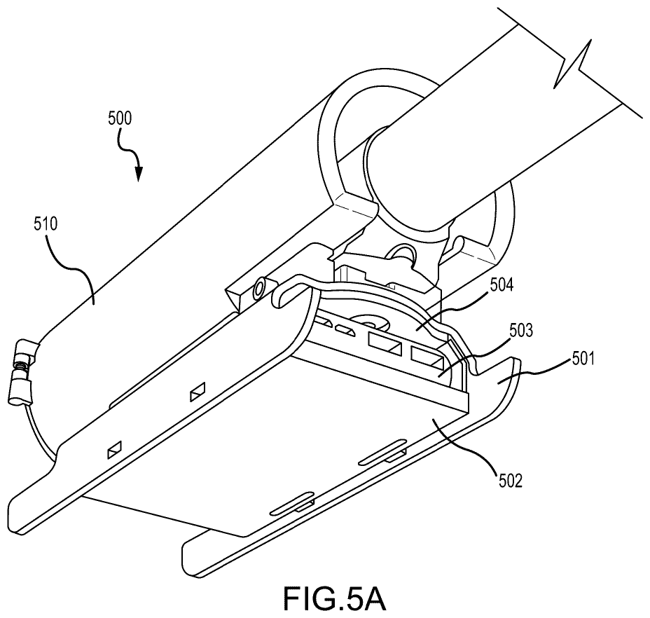

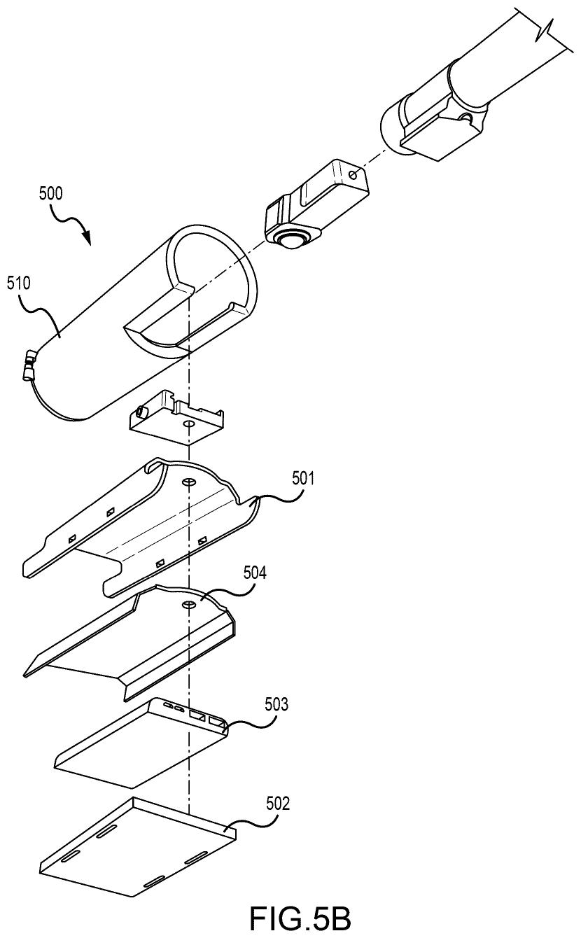

Turning now to FIG. 5A, an exemplary embodiment of an apparatus for undercarriage photography 500 is shown in an opaque view. Apparatus 500 may comprise sled 501, tray 502, battery 503, liner 504, and/or housing 510. Sled 501 may be similar in many respects to sled 204 (FIG. 2). Sled 501 may comprise one or more cutouts or grooves that allow for coupling of tray 502. Tray 502 may be approximately planar in shape and may couple to sled 501 using one or more protrusions and/or fasteners. Tray 502 may be made of a rigid material capable of supporting a weight of battery 503. Battery 503 may rest in a cavity created by sled 501 and tray 502. In some embodiments, the cavity can comprise one or more doors, latches, or coverings positioned to hold battery 503 within the cavity while also allowing battery 503 to be accessed for charging and/or replacement. Tray 502 can comprise a quick release mechanism for allowing easy uncoupling from sled 501. For example, one or more lateral tabs on tray 502 can be disengaged from one or more openings on sled 501 to uncouple tray 502 from sled 501. In many embodiments, battery 503 may be electrically coupled to a camera (e.g., camera 301 (FIG. 3)) and/or one or more motors in apparatus 500. For example, battery 503 may be electrically coupled to a motor configured to extend and contract a telescopic portion of apparatus 500 (e.g., first central support 101 (FIG. 1) and second central support 102 (FIG. 2)). Liner 504 can be constructed of a soft and/or cushiony material capable of lowering forces exerted on battery 503 and/or protecting battery 503 from damage to due to dust, dirt, grime, or other deleterious elements. For example, liner 504 may have a felt or microfiber exterior. As another example, liner 504 may be cushioned or padded to absorb jostles and bumps during transport, storage, or usage. In many embodiments, liner 504 may be removably coupled to sled 501 and/or tray 502 (e.g., via hook and loop fasteners), thereby allowing it to be cleaned or replaced.

Turning now to FIG. 5B, the apparatus for undercarriage photography 500 is shown in an exploded, opaque view. Housing 510 can be a top most element of apparatus 500 and be coupled to one or more of sled 501 and/or liner 504. In many embodiments, housing 510 can be coupled to sled 501 and/or liner 504 via one or more mounts (e.g., mount 203 (FIG. 2)). Sled 501 can liner 504 can be complementary in shape such that liner 504 can be nestled within an underside of sled 501. Battery 503 can be located underneath one or more of sled 501 and/or liner 504. Tray 502 can be located underneath and support a weight of battery 503,

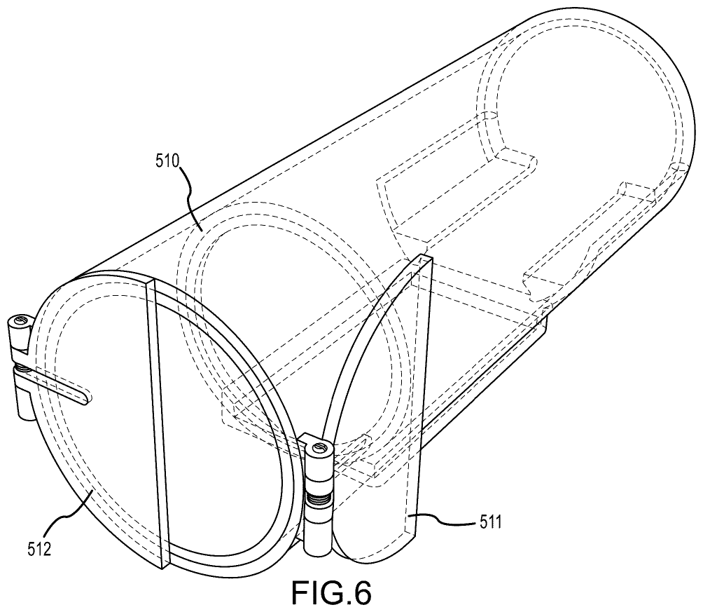

Turning now to FIG. 6, a front, transparent view of housing 510 is shown. Housing 510 may comprise one or more doors 511 and 512. Doors 511 and 512 may be hinged and open outward away from housing 510. In this way, when housing 510 is retracted, a camera may push open doors 511 and 512. In many embodiments, doors 511 and 512 may automatically close when not obstructed. For example, one or more of doors 511 and 512 may have spring biased hinges. Doors 511 and 512 may be lined with a soft and/or cushiony material capable of lowering forces exerted on camera assembly 300 (FIG. 1) and/or protecting elements of camera assembly 300 (FIG. 1) from damage to due to dust, dirt, grime, or other deleterious elements. In some embodiments, doors 511 and 512 can be replaced with a slip on covering or a screw on cap.

Although an apparatus for undercarriage photography has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-6 may be modified, and that the foregoing discussion of certain of these embodiments does not necessarily represent a complete description of all possible embodiments.

For simplicity and clarity of illustration, the drawing figures illustrate the general manner of construction, and descriptions and details of some features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, In many embodiments, be defined with respect to operations carried out as soon as practically possible upon occurrence of a triggering event. A triggering event may include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” may mean real time less a time delay for processing (e.g., determining) and/or transmitting data. The particular time delay may vary depending on the type and/or amount of the data, the processing speeds of the hardware, the transmission capability of the communication hardware, the transmission distance, etc. However, in many embodiments, the time delay may be less than approximately one second, two seconds, five seconds, or ten seconds.

As defined herein, “approximately” can, In many embodiments, mean within plus or minus ten percent of the stated value. In many embodiments, “approximately” may mean within plus or minus five percent of the stated value. In further embodiments, “approximately” may mean within plus or minus three percent of the stated value. In yet other embodiments, “approximately” may mean within plus or minus one percent of the stated value.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. An apparatus for photographing an undercarriage of a vehicle, the apparatus comprising:
a telescoping support comprising a first end and a second end;
a weight coupled to the first end of the telescoping support;
a camera coupled to the second end of the telescoping support; and
a housing slidably coupled to the telescoping support.

2. The apparatus of claim 1, wherein the housing comprises a cavity for receiving and enclosing the camera.

3. The apparatus of claim 2, further comprising a housing mount coupled to the second end of the telescoping support, the housing mount configured to couple the housing when the housing encloses the camera.

4. The apparatus of claim 3, wherein the housing mount comprises a protrusion, the housing comprises a cutout configured to slidably receive the protrusion when the housing encloses the camera.

5. The apparatus of claim 2, wherein the cavity is lined with a cushioned material.

6. The apparatus of claim 1, wherein the weight is configured to level the apparatus.

7. The apparatus of claim 1, further comprising a sled coupled to the housing.

8. A method of creating an apparatus for photographing an undercarriage of a vehicle, the method comprising:
coupling a weight to a first end of a telescoping support;
coupling a camera to a second end of the telescoping support; and
slidably coupling a housing to the telescoping support.

9. The method of claim 8, wherein the housing comprises a cavity for receiving and enclosing the camera.

10. The method of claim 9, further comprising coupling a housing mount to the second end of the telescoping support, the housing mount configured to couple the housing when the housing encloses the camera.

11. The method of claim 10, wherein the housing mount comprises a protrusion, the housing comprises a cutout configured to slidably receive the protrusion when the housing encloses the camera.

12. The method of claim 9, wherein the cavity is lined with a cushioned material.

13. The method of claim 8, wherein the weight is configured to level the apparatus.

14. The method of claim 8, further comprising coupling a sled to the housing.

15. A method for using an apparatus for photographing an undercarriage of a vehicle, the method comprising:
sliding the apparatus for photographing the undercarriage of the vehicle underneath the vehicle, wherein the apparatus for photographing the undercarriage of the vehicle comprises:
a telescoping support comprising a first end and a second end;
a weight coupled to the first end of the telescoping support;
a camera coupled to the second end of the telescoping support; and
a housing slidably coupled to the telescoping support;
actuating the camera; and
removing the apparatus for photographing the undercarriage of the vehicle from underneath the vehicle.

16. The method of claim 15, further comprising sliding the camera out of a cavity in the housing.

17. The method of claim 16, further comprising slidably uncoupling a housing mount from the housing, wherein the housing mount is coupled to the second end of the telescoping support.

18. The method of claim 17, further comprising slidably uncoupling a protrusion on the housing mount from a cutout on the housing.

19. The method of claim 16, wherein the cavity is lined with a cushioned material.

20. The method of claim 15, wherein the weight is configured to level the apparatus.
